(19) United States
(12) Patent Application Publication
(10) Pub. No.: US 2019/0205702 A1
(43) Pub. Date: Jul. 4, 2019

(54) SYSTEM AND METHOD FOR RECOMMENDING FEATURES FOR CONTENT PRESENTATIONS

(71) Applicant: Cognant LLC, Mountain View, CA (US)

(72) Inventors: Kent Shi, Sunnyvale, CA (US); Arun Nedunchezhian, Milpitas, CA (US); Arun Kejariwal, Fremont, CA (US)

(21) Appl. No.: 16/202,678

(22) Filed: Nov. 28, 2018

Related U.S. Application Data
(60) Provisional application No. 62/611,040, filed on Dec. 28, 2017.

(51) Int. Cl. G06K 9/62; G06N 3/04; G06N 7/00; G06K 9/46

(52) U.S. Cl. CPC G06K 9/6262; G06K 9/46; G06N 7/00; G06N 3/04

(57) ABSTRACT

A method, a system, and an article are provided for developing and using a predictive model for analyzing and creating items of content. An example method includes: providing a plurality of items of content in which each item of content includes an image, a video, and/or a sound; extracting a plurality of features from each item of content; determining a performance indicator for each item of content, wherein the performance indicator provides an indication of user responses to presentations of the item of content; developing a model to predict the performance indicator for each item of content based on the plurality of features; based on the model, determining a sensitivity between the performance indicator and each feature; and developing a new item of content based on the determined sensitivities.

### CROSS-REFERENCE TO RELATED APPLICATIONS

This application claims the benefit of U.S. Provisional Patent Application No. 62/611,040, filed Dec. 28, 2017, the entire contents of which are incorporated by reference herein.

### BACKGROUND

The present disclosure relates to digital content and, in particular, to systems and methods for developing and using a model to predict user responses to digital content and, based on the model, developing user content to achieve a desired user response.

Client devices are generally capable of presenting a wide variety of content, including images, video, audio, and combinations thereof. Such content can be stored locally on client devices and/or can be sent to the client devices from server computers over a network (e.g., the Internet). To watch an online movie, for example, a user of a client device can download a copy of the movie and/or can stream the movie from a website, software application, or other channel.

Content is often developed and used to achieve a certain response from a person exposed to the content. Some content can encourage a person to take a certain action, such as purchasing a product or service. Other content can be configured to elicit certain emotions or feelings in the person. It is often not clear, however, which features in an item of content have the greatest influence on the people who are exposed to the content.

### SUMMARY

In general, the subject matter of this disclosure relates to the development of a predictive model that can be used to develop items of content (e.g., images, videos, text, and/or sounds) that achieve a desired response from users who are exposed to the content. Multiple items of content can be presented on user client devices and responses to the presentations can be measured and used to determine one or more performance indicators, which can provide an indication of the user responses. The items of content can also be analyzed to identify or extract any features present in the content. The features can be or include, for example, the presence, absence, degree, or quantity of one or more video, image, text, and/or audio elements. A predictive model is then developed based on the determined performance indicators and the extracted content features. The predictive model can be configured to predict a performance indicator for an item of content, based on the features present in the item of content. The model can be used to determine which content features have the greatest influence on the performance indicator. Finally, new items of content can be created that include these influential content features, and the new items of content can be presented to users in an effort to achieve the desired user response.

Advantageously, the systems and methods described herein can provide a data-driven tool for determining which features should be included in new items of content, so that a desired user response to the content can be achieved. Compared to prior approaches involving human guess-work or trial and error, the automated approach described herein represents a significant improvement in both accuracy and efficiency. The systems and methods described herein can determine the most important content features based on measurements of user responses to presented content and extractions of features from such content. The predictive model allows content developers to determine the influence that certain content features can have on users exposed to content.

In one aspect, the subject matter described in this specification relates to a method. The method includes: providing a plurality of items of content, each item of content including at least one of an image, a video, a sound, and any combination thereof; extracting a plurality of features from each item of content; determining a performance indicator for each item of content, the performance indicator including an indication of user responses to presentations of the item of content; developing a model to predict the performance indicator for each item of content based on the plurality of features; based on the model, determining a sensitivity between the performance indicator and each feature; and developing a new item of content based on the determined sensitivities.

In certain examples, providing the plurality of items of content can include presenting the plurality of items of content on user client devices. Extracting the plurality of features can include using computer vision and/or convolutional neural networks. The plurality of features can include at least one element in a digital image. Determining the performance indicator for each item of content can include determining user responses to presentations of the item of content on user client devices.

In some implementations, the user responses can include user interactions with the item of content on the user client devices. The model can be or include a regression model. Developing the new item of content can include identifying a subset of the plurality of features that have highest sensitivities. Developing the new item of content can include modifying an existing item of content. The method can include: presenting the new item of content on a plurality of user client devices; determining the performance indicator for the new item of content; and updating the model based on the performance indicator for the new item of content.

In another aspect, the subject matter described in this specification relates to a system having one or more computer processors programmed to perform operations including: providing a plurality of items of content, each item of content including at least one of an image, a video, a sound, and any combination thereof; extracting a plurality of features from each item of content; determining a performance indicator for each item of content, the performance indicator including an indication of user responses to presentations of the item of content; developing a model to predict the performance indicator for each item of content based on the plurality of features; based on the model, determining a sensitivity between the performance indicator and each feature; and developing a new item of content based on the determined sensitivities.

In various examples, providing the plurality of items of content can include presenting the plurality of items of content on user client devices. Extracting the plurality of features can include using computer vision and/or convolutional neural networks. The plurality of features can include at least one element in a digital image. Determining the performance indicator for each item of content can include determining user responses to presentations of the item of content on user client devices.

In certain implementations, the user responses can include user interactions with the item of content on the user client devices. The model can be or include a regression model. Developing the new item of content can include identifying a subset of the plurality of features that have highest sensitivities. Developing the new item of content can include modifying an existing item of content. The operations can include: presenting the new item of content on a plurality of user client devices; determining the performance indicator for the new item of content; and updating the model based on the performance indicator for the new item of content.

In another aspect, the subject matter described in this specification relates to an article. The article includes a non-transitory computer-readable medium having instructions stored thereon that, when executed by one or more computer processors, cause the computer processors to perform operations including: providing a plurality of items of content, each item of content including at least one of an image, a video, a sound, and any combination thereof; extracting a plurality of features from each item of content; determining a performance indicator for each item of content, the performance indicator including an indication of user responses to presentations of the item of content; developing a model to predict the performance indicator for each item of content based on the plurality of features; based on the model, determining a sensitivity between the performance indicator and each feature; and developing a new item of content based on the determined sensitivities.

Elements of embodiments described with respect to a given aspect of the invention can be used in various embodiments of another aspect of the invention. For example, it is contemplated that features of dependent claims depending from one independent claim can be used in apparatus, systems, and/or methods of any of the other independent claims

### DESCRIPTION OF THE DRAWINGS

FIG. 1 is a schematic diagram of an example system for developing and using a predictive model for creating content that achieves a desired user response.

FIG. 2 is a schematic diagram of a method of developing and using a predictive model for creating content that achieves a desired user response.

FIG. 3 is a flowchart of an example method of developing and using a predictive model for creating content that achieves a desired user response.

### DETAILED DESCRIPTION

In general, content presented on user client devices can be in the form of images, videos, audio, text, and combinations thereof. Each item of content can include one or more features such as, for example, image features, video features, audio features, and/or text features. The image features can include, for example, people, faces, facial expressions, animals (e.g., puppies, kittens, or virtual creatures), buildings, machines (e.g., cars, airplanes, or trains), weapons, natural items (e.g., trees, lakes, etc.), colors, text, and any other image objects (e.g., gold coins, playing cards, etc.). The image features can be presented through combinations of pixels or other image elements and can occupy entire images or portions thereof. The video features can include, for example, any of the image features and/or changes to the image features that occur over time. For example, the video features can include movements of image features, such as people or animals. The audio features can include, for example, natural sounds (e.g., thunder or animal sounds), voices, spoken words, machine sounds, etc., presented in a video or audio signal. The text features can include, for example, one or more combinations of letters or words presented in an image or video.

In various examples, features for an item of content can be identified as either being present or absent (e.g., a binary feature identification) or can be can be identified as being present in a certain degree or amount (e.g., a non-binary feature identification). For example, when an image includes three people but does not include a car, a binary feature identification for the image can indicate that the image includes at least one person but does not include any cars. A non-binary feature identification for the image can indicate that the image includes three people and zero cars. Additionally or alternatively, non-binary feature identifications can be used to characterize a degree to which certain sentiment or emotion may be present in or elicited by an item of content (e.g., a degree of happiness or sadness). Binary and/or non-binary feature identifications can be used to develop the predictive models described herein and/or can be used as inputs to such models.

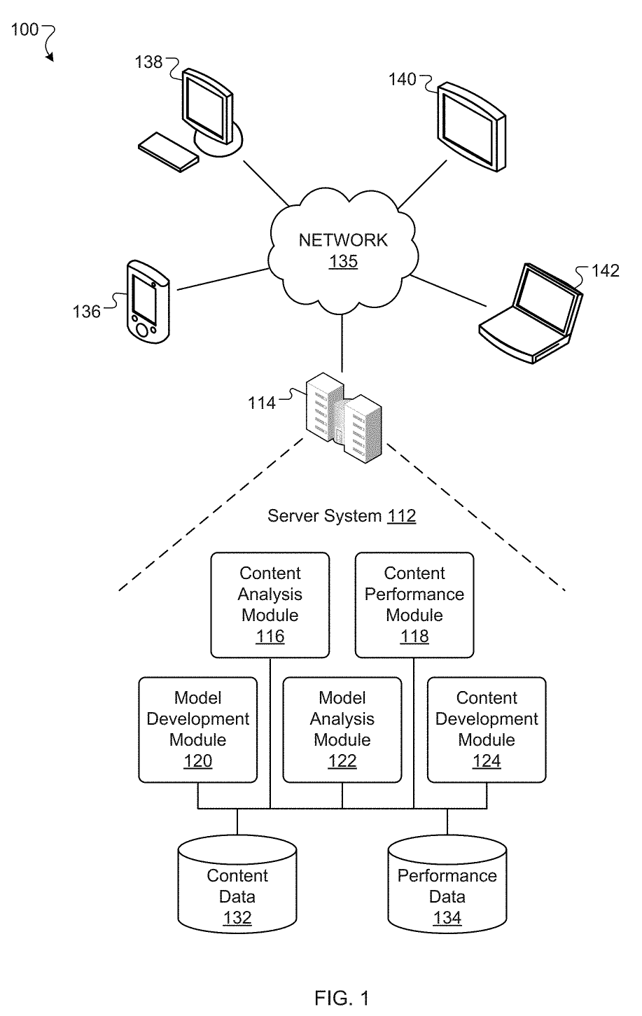

FIG. 1 illustrates an example system 100 for developing and using a predictive model for creating content that achieves a desired user response. A server system 112 provides functionality for collecting data related to presentations of digital content, developing a predictive model, and using the predictive model to create new content. The server system 112 includes software components and databases that can be deployed at one or more data centers 114 in one or more geographic locations, for example. In certain instances, the server system 112 is, includes, or utilizes a content delivery network (CDN). The server system 112 software components can include a content analysis module 116, a content performance module 118, a model development module 120, a model analysis module 122, and a content development module 124. The software components can include subcomponents that can execute on the same or on different individual data processing apparatus. The server system 112 databases can include a content data 132 database, and a performance data 134 database. The databases can reside in one or more physical storage systems. The software components and data will be further described below.

A software application, such as, for example, a web-based application, can be provided as an end-user application to allow users to interact with the server system 112. The software application can relate to and/or provide a wide variety of functions and information, including, for example, entertainment (e.g., a game, music, videos, etc.), business (e.g., word processing, accounting, spreadsheets, etc.), news, weather, finance, sports, etc. In preferred implementations, the software application is configured to present digital content on the client devices and allow users to interact with the digital content, for example, by clicking or selecting the digital content. The software application or components thereof can be accessed through a network 135 (e.g., the Internet) by users of client devices, such as a smart phone 136, a personal computer 138, a tablet computer 140, and a laptop computer 142. Other client devices are possible. In alternative examples, the content data 132 database, the performance data 134 database, or any portions thereof can be stored on one or more client devices. Additionally or alternatively, software components for the system 100 (e.g., the content analysis module 116, the content performance module 118, the model development module 120, the model analysis module 122, and/or the content development module 124) or any portions thereof can reside on or be used to perform operations on one or more client devices.

FIG. 1 depicts the content analysis module 116, the content performance module 118, the model development module 120, the model analysis module 122, and the content development module 124 as being able to communicate with the content data 132 database and the performance data 134 database. The content data 132 database generally includes digital content and/or information related to digital content, such as, for example, descriptions of features (e.g., image or sound elements) present in the digital content. The performance data 134 database generally includes information related to user responses to the presentations of digital content on user client devices. Such information can include, for example, one or more performance indicators that are or include an indication of user responses to digital content. The performance indicators for an item of content can be or include, for example, a display time (e.g., a length of time the item of content was displayed on client devices before being closed), a click-through rate (e.g., a ratio of a number of clicks on the item of content to a number of presentations of the item of content), and a click-to-install ratio (e.g., a ratio of a number of clicks on the item-of-content to a number of software installations derived from the item of content). Other performance indicators are possible.

In some examples, click through rate (CTR) for an item of content can be calculated using the following equation:

$$CTR = \frac{Clicks}{Impressions} , \qquad ( 1 )$$

where Clicks is the number of clicks (or user selections) on the item of content and Impressions is the number of presentations of the item of content on user client devices. CTR calculated in this manner can decay over time as more users view the item of content. To address this time variation, CTR can be calculated for one or more specific periods of time. In one example, CTR can be calculated based on an initial 15 days of presentations of the item of content, though other suitable time periods can be used. Using equation (1), for example, CTR can be calculated by dividing the number of Clicks over the initial 15 days by the number of Impressions over the initial 15 days.

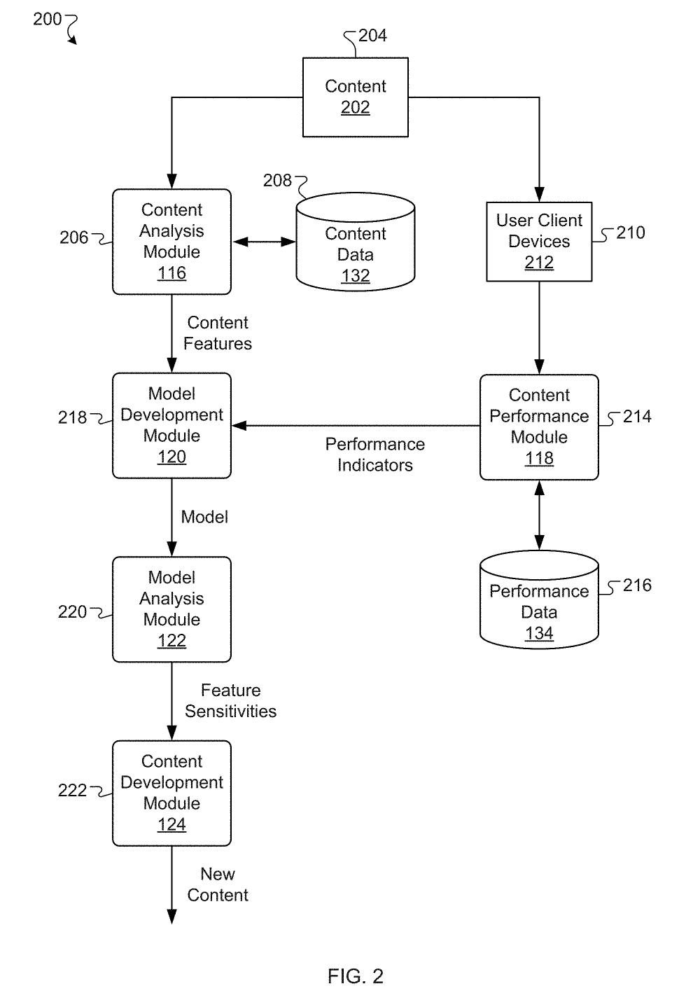

Referring to FIG. 2, in various examples, a method 200 utilizes the content analysis module 116, the content performance module 118, the model development module 120, the model analysis module 122, and/or the content development module 124 to develop and use a predictive model for creating digital content. A plurality of items of content 202 are provided (step 204). Each item of content can be or include, for example, an image, a video, a sound, text, and/or any combination thereof. The items of content are analyzed (step 206) by the content analysis module 116 to determine or extract one or more features associated with each item of content. To extract the features, the content analysis module 116 can open and/or automatically scan or analyze each item of content. In some instances, the content analysis module 116 can utilize computer vision techniques, such as, for example, support vector machine, convolutional neural networks (e.g., region-based convolutional network (R-CNN), you only look once (YOLO), single-shot detector (SSD), and/or neural architecture search net (NASNet)), and/or deep learning, for extracting the one or more features. In the case of images, for example, the content analysis module 116 can identify one or more objects, items, colors, text, or similar features depicted in each image (e.g., as formed by the image pixels). Additionally or alternatively, in the case of videos, the content analysis module 116 can identify one or more objects, items, colors, sounds, and/or text, or movements or other changes to such objects, items, colors, sounds, and/or text depicted in each video. Additionally or alternatively, in the case of audio content, the content analysis module 116 can identify the presence or absence of certain sounds (e.g., voices, spoken words, animal noises, machine noises, etc.), the content of such sounds, or any changes to the sounds. The features extracted by the content analysis module 116 for each item of content can be written (step 208) to the content data 132 database. The stored features for each item of content can be accessed later by the content analysis module 116 or other system components, as needed.

In some examples, feature extraction can be performed manually or through a combination of manual and automatic feature extraction techniques. In some examples, one or more people can be exposed to items of content and can record the features present in the content, such as, for example, objects, characters, emotions, background colors, text, and the like. Any number of features can be recorded for images, videos, and other forms of content. For one example set of images and videos, about 40 features were identified for the images and about 45 features were identified for the videos. Additionally or alternatively, features can be extracted from content through the use of surveys, which can solicit comments from one or more people on items of content. Survey participants can be asked to provide personal feedback on the content, including comments related to what the participants like or dislike for each item of content. The comments can have positive and/or negative sentiments. The survey responses can be transformed to Boolean features that indicate whether a feature is present or absent.

The items of content 202 can also be presented (step 210) on a plurality of client devices 212 (e.g., the smart phone 136, the personal computer 138, the tablet computer 140, and the laptop computer 142). Users of the client devices can view, listen to, and/or interact with the items of content presented on the client devices. For example, images and video content can be displayed and/or sounds can be played on the client devices. Additionally or alternatively, users of the client devices can click, select, or take other actions (e.g., visit websites, install software applications, complete transactions, etc.) in response to the content presentations. A record of each content presentation and the user responses to the content presentation can be provided to the content performance module 118, which can analyze (step 214) the content presentations and the user responses to determine one or more performance indicators (e.g., CTR) for each item of content. The record for each content presentation and/or the performance indicators can be written (step 216) to the performance data 134 database. The stored performance indicators and other content presentation information for each item of content can be accessed later by the content performance module 118 or other system components, as needed.

The model development module 120 receives the content features from the content analysis module 116 and the performance indicators from the content performance module 118 and uses the content features and the performance indicators to develop (step 218) the predictive model. In general, the predictive model is configured to predict performance indicators for a given set of content features. For example, the predictive model can receive a set of features for an item of content as input and provide a predicted performance indicator for the item of content as output. The predictive model can be or include, for example, one or more equations (e.g., regression equations) and/or classifiers.

In some examples, the predictive model is or includes a regression equation in which the content features are independent variables and the dependent variable is a performance indicator P. An example linear regression equation for the predictive model can be given by

P=c₀+c₁*F₁+c₂*F₂+ . . . +cₙ*Fₙ, (2)

where c₀ is a constant, c₁, c₂, . . . , cₙ are coefficients, and F₁, F₂, . . . , Fₙ are the content features. The constant c₀ and the coefficients c₁, c₂, . . . , cₙ can be determined by fitting equation (2) to the performance indicators and content features determined for the content 202 by the content performance module 118 and content analysis module 116, respectively. In general, values for the constant c₀ and the coefficients c₁, c₂, . . . , cₙ are chosen such that an overall error (e.g., a least squares error) between the performance indicators P calculated by equation (2) and the performance indicators determined by the content performance module 118 is minimized.

In certain implementations, the predictive model is or includes Ridge, Lasso, Elastic Net, Adaptive Lasso, Group Lasso, Randomized Lasso, and/or other regression models. Ridge regression may not zero out coefficients and/or may take all coefficients in the regression equation. Lasso can perform variable selection implicitly, which can be more suitable for the systems and methods described herein. There are multiple variations of Lasso that can be used for feature selection.

In one example, experiments were conducted to evaluate the performance of various regression models for a set of images and a corresponding performance indicator. Table 1 lists the root-mean-square error (RMSE) values calculated for each model. As indicated, the top performing model in this example was the Adaptive Lasso model, which had the lowest RMSE.

TABLE 1
RMSE values for an experiment with various regression models

| Regression Technique | RMSE |
|---|---|
| Ordinary Least Squares | 75.971 |
| Ridge Regression | 28.751 |
| Lasso Regression | 19.167 |
| Randomized Lasso | 19.589 |
| Adaptive Lasso | 16.185 |
| ElasticNet | 29.326 |
| Group Lasso | 90.294 |

In some instances, multicollinearity issues can occur when two or more content features are highly correlated. For example, when two content features are always either present or absent in a set of images, the two features can be highly correlated and it can be difficult for a predictive model to attribute changes in the performance indicator to just one of the features.

Multicollinearity can affect overall accuracy of the model and there are various approaches for addressing the issue. For example, Lasso regression can perform feature selection implicitly, by selecting important features and setting coefficients for the other features to zero. For a group of collinear features, Lasso can choose any one of the features and set the coefficients to zero for the other features. In one example, each image in a set of images can either include all of the following features or not include any of these features: a yellow background color, a military base, and a vehicle. Lasso can address multicollinearity in this example by selecting one of the collinear features (e.g., the yellow background color) and setting coefficients for the other features to zero. The resulting model, however, may indicate that the selected feature is more important than the other features, when in reality this difference in importance may not be true.

In some examples, collinear features can be clustered together and treated as a group rather than as an individual feature. With this approach, the group of collinear features can be considered to be a single feature that is associated with a single coefficient value in the regression model.

To assess the influence of feature collinearity, a variance inflation factor (VIF) approach can be used. VIF can provide a measure of how much the variance of an estimated regression coefficient is increased due to collinearity. VIF can be represented by the following equation:

$${VIF}_{i} = \frac{1}{1 - {R}_{i}^{2}} , \qquad ( 3 )$$

where, Rᵢ² is a coefficient of determination of a regression equation in which feature Fᵢ is on the left-hand side and all other features are on the right hand side. When i=1, this equation can be given by

F₁=b₂*F₂++ . . . +bₙ*Fₙ+b₀+e, (4)

where, b₀ is a constant, b₂ to bₙ are coefficients, and e is an error term. The VIF of a feature can provide a measure of how large the standard error is compared to what the standard error would be if the feature were uncorrelated with other features in the model. Hence, a large VIF value (e.g., >7) for a feature can suggest high collinearity and inflated standard errors. Such features can be good to drop in standard regression.

Additionally or alternatively, collinear features can be identified by finding pairwise correlation between features using a correlation coefficient, such as, for example, Pearson Coefficient, which can be defined as follows:

$${ρ}_{G , H} = \frac{E [ ( G - {μ}_{G} ) ( H - {μ}_{H} ) ]}{{σ}_{G} {σ}_{H}} , \qquad ( 5 )$$

where G is the first content feature values, H is the second content feature values, μ_{G} is the mean of G, μ_{H} is the mean of H, σ_{G} is the standard deviation of G, σ_{H} is the standard deviation of H, and E is the expectation. The Pearson Coefficient can identify features that are highly correlated and should be clustered together. Based on experiments, a Pearson Coefficient greater than 0.5 can provide a good threshold for clustering features, although other Pearson Coefficient thresholds can be used. A low threshold can result in excessively large clusters, while a high threshold can result in too many single member clusters.

Additionally or alternatively, the predictive model can be or include a classifier such as, for example, one or more linear classifiers (e.g., Fisher's linear discriminant, logistic regression, Naive Bayes classifier, and/or perceptron), support vector machines (e.g., least squares support vector machines), quadratic classifiers, kernel estimation models (e.g., k-nearest neighbor), boosting (meta-algorithm) models, decision trees (e.g., random forests, Gradient Boosting Trees), neural networks, and/or learning vector quantization models. Other classifiers can be used. The classifier can be trained using the content features from the content data 132 database and the performance indicators from the performance data 134 database. Once trained, the classifier can receive content features as input and provide performance indicators as output. In some preferred examples, random forests and/or gradient boosting trees can be used for the predictive model to determine performance indicators and rank the content features.

Still referring to FIG. 2, once the predictive model has been developed by the model development module 120, the model can be analyzed (step 220) by the model analysis module 122 to determine how sensitive the performance indicator P is to the various content features, including any clusters of features. For example, referring again to equation (2), the value for each coefficient c₁, c₂, . . . , cₙ can represent the influence that the corresponding feature F₁, F₂, . . . , Fₙ has on the performance indicator P. When the value for c₁ is large, for example, the performance indicator P is generally more sensitive to the corresponding feature F₁, such that changes in F₁ can have a big influence on the performance indicator P. Conversely, when the value for c₁ is small, the performance indicator P is generally less sensitive to the corresponding feature F₁, such that changes in F₁ can have a minimal influence on the performance indicator P. Each coefficient c₁, c₂, . . . , and cₙ can alternatively be referred to as a sensitivity between the performance indicator P and the corresponding content feature F₁, F₂, . . . , and Fₙ. Additionally or alternatively, the influence that a change in a content feature Fᵢ has on the value of the performance indicator P can be referred to herein as the sensitivity of the performance indicator P to the content feature Fᵢ. The sensitivity can be expressed mathematically as a partial derivative of the performance indicator P with respect to the content feature Fᵢ, as follows:

$$Sensitivity = \frac{\partial P}{\partial {F}_{i}} . \qquad ( 6 )$$

Multiplying the partial derivative by an amount of change in the content feature Fᵢ can provide a corresponding amount of change in the performance indicator P.

The model analysis module 122 can determine the sensitivities in various ways. For example, when the predictive model is or includes equation (2), the sensitivities can be identified from and/or can be equal to the coefficients c₁, c₂, . . . , and cₙ. Alternatively or additionally, the model analysis module can determine the sensitivities by calculating the partial derivatives for each feature, as shown in equation (6). This can be done numerically, for example, by using the model to calculate the performance indicator P at multiple values for each feature. The partial derivative for a feature can be determined from equation (6) by dividing a calculated amount of change in the performance indicator P by a corresponding amount of change in the feature. In some examples, the model analysis module 122 can identify the content features having the highest sensitivities. For example, the model analysis module 122 can select k features that have the highest sensitivities among all the features, where k can be any integer, such as 2, 5, or 10.

The determined feature sensitivities can then be provided to the content development module 124, which can be used to develop (step 222) and/or make recommendations for one or more new items of content. The content development module 124 can use the feature sensitivities from the model analysis module 122 to identify the content features that have the greatest influence on the performance indicator P. For example, if content features F₁ and F₃ have high sensitivities (e.g., positive and/or large values), the content development module 124 can develop content that includes these features and/or a large number or amount of these features, in an effort to maximize the performance indicator P. Additionally or alternatively, if content features F₂ and F₄ have low sensitivities (e.g., negative and/or small values), the content development module 124 can develop content that does not include these features and/or includes only a small number or amount of these features. Once the desired features have been identified, the content development module 124 can create new items of content and/or modify existing items of content that include the desired features.

In some examples, the content development module 124 can create and/or modify items of content automatically, for example, using suitable image or video editing techniques (e.g., to add or remove one or more features). Additionally or alternatively, the content development module 124 can be or include image or video editing software that one or more users can use to create and/or edit items of content. In certain instances, the content development module 124 can provided recommendations to content creators regarding the features that should be incorporated into content and/or not included in the content. Such recommendations can be based on the features having the highest or lowest sensitivities, for example, as identified by the model analysis module 122. The recommendations can be provided periodically (e.g., every 1, 5, 10, or 15 days).

In various examples, regression models can be developed and used to create content for specific groups of users. For example, a performance indicator for items of content can be determined according to user geographical location or other user characteristics, such as, for example, user device type and/or user software application preferences or usage. The resulting models can be used to determine which content features are most important for different user groups. For example, users in some geographical locations may respond more favorably to content having one set of features, while users in other geographical locations may respond more favorably to content having a different set of features. By developing and using a separate predictive model for each geographical location (or other user characteristic), performance indicator predictions can be more accurate, and resulting items of content can be more accurately tailored to achieve desired user responses.

In various instances, as described herein, certain content features can be identified as being collinear. In such cases, any one of the collinear features can be considered for inclusion in new items of content, without also including the other features. Additionally or alternatively, the collinear features can be considered for inclusion as a group or other combination in new items of content. Considering the collinear features as a group can provide the content development module 124 and/or content developers with more context.

In one example, three versions of an image were created in which each image had one of three recommended features, F₁, F₂, and F₃. Each image was then presented many times on multiple user client devices and the click through rate (CTR) was determined for each image. The results are presented in Table 2, which indicates that the CTR was highest for the image having feature F₂.

TABLE 2
Click through rates associated with three versions of an image.

| Recommended | | | Click Through |
|---|---|---|---|
| Feature | Presentations | Clicks | Rate (CTR) |
| F₁ | 422,360 | 5,559 | 1.32% |
| F₂ | 565,248 | 8,205 | 1.45% |
| F₃ | 584,158 | 7,391 | 1.27% |

In preferred implementations, the features for each item of content can be added to a database (e.g., a My SQL database) that can maintain data for the content features. The data can include the following fields for each item of content: a name or identification of the content, a list of features present in the content, and one or more performance indicators for the content. The database can be updated as new items of content are created and/or as new measurements of performance indicators are obtained. The database can be stored in the content data 132 database and/or in the performance data 134 database. The database can be accessed by the model development module 120 and other system components, as needed.

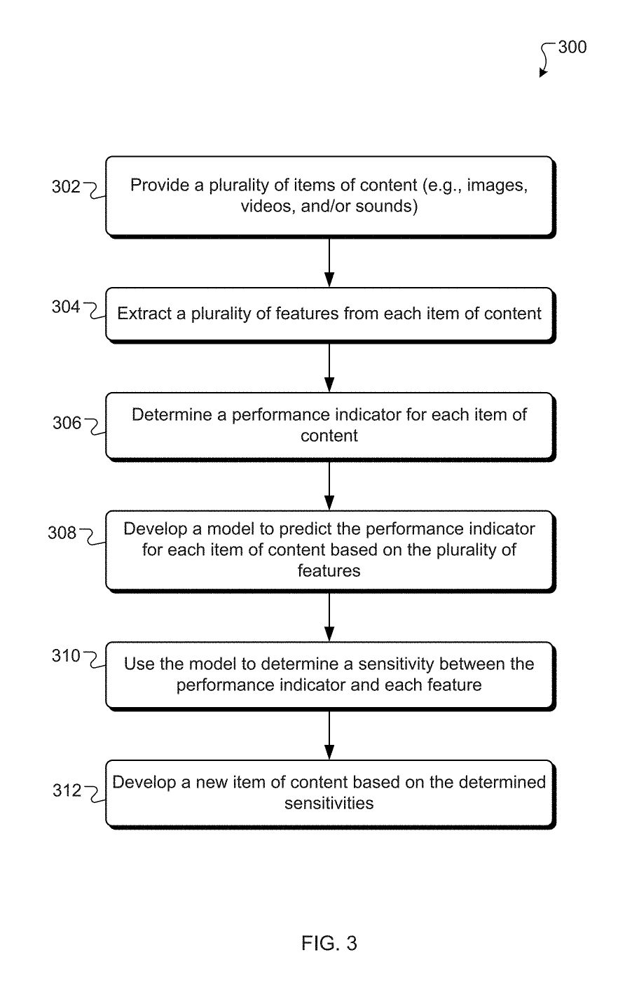

FIG. 3 illustrates an example computer-implemented method of developing and using a predictive model for creating content that elicits a desired user response. A plurality of items of content are provided (step 302) in which each item of content includes an image, a video, a sound, or any combination thereof. A plurality of features are extracted (step 304) from each item of content. A performance indicator is determined (step 306) for each item of content. The performance indicator includes an indication of user responses to presentations of the item of content. A model is developed (step 308) to predict the performance indicator for each item of content based on the plurality of features. Based on the model, a sensitivity between the performance indicator and each feature is determined (step 310). A new item of content is developed (step 312) based on the determined sensitivities.

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic disks, magneto-optical disks, optical disks, or solid state drives. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including, by way of example, semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse, a trackball, a touchpad, or a stylus, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what can be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features can be described above as acting in certain combinations and even initially claimed as such, one or more features from a claimed combination can in some cases be excised from the combination, and the claimed combination can be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing can be advantageous.

What is claimed is:

1. A method, comprising:
providing a plurality of items of content, each item of content comprising at least one of an image, a video, a sound, and any combination thereof;
extracting a plurality of features from each item of content;
determining a performance indicator for each item of content, the performance indicator comprising an indication of user responses to presentations of the item of content;
developing a model to predict the performance indicator for each item of content based on the plurality of features;
based on the model, determining a sensitivity between the performance indicator and each feature; and
developing a new item of content based on the determined sensitivities.

2. The method of claim 1, wherein providing the plurality of items of content comprises:
presenting the plurality of items of content on user client devices.

3. The method of claim 1, wherein extracting the plurality of features comprises:
using at least one of computer vision, convolutional neural networks, and combinations thereof.

4. The method of claim 1, wherein the plurality of features comprises at least one element in a digital image.

5. The method of claim 1, wherein determining the performance indicator for each item of content comprises:
determining user responses to presentations of the item of content on user client devices.

6. The method of claim 5, wherein the user responses comprise user interactions with the item of content on the user client devices.

7. The method of claim 1, wherein the model comprises a regression model.

8. The method of claim 1, wherein developing the new item of content comprises:
identifying a subset of the plurality of features comprising highest sensitivities.

9. The method of claim 1, wherein developing the new item of content comprises modifying an existing item of content.

10. The method of claim 1, further comprising:
presenting the new item of content on a plurality of user client devices;
determining the performance indicator for the new item of content; and
updating the model based on the performance indicator for the new item of content.

11. A system, comprising:
one or more computer processors programmed to perform operations comprising:
providing a plurality of items of content, each item of content comprising at least one of an image, a video, a sound, and any combination thereof;
extracting a plurality of features from each item of content;
determining a performance indicator for each item of content, the performance indicator comprising an indication of user responses to presentations of the item of content;
developing a model to predict the performance indicator for each item of content based on the plurality of features;
based on the model, determining a sensitivity between the performance indicator and each feature; and
developing a new item of content based on the determined sensitivities.

12. The system of claim 11, wherein providing the plurality of items of content comprises:
presenting the plurality of items of content on user client devices.

13. The system of claim 11, wherein the plurality of features comprises at least one element in a digital image.

14. The system of claim 11, wherein determining the performance indicator for each item of content comprises:
determining user responses to presentations of the item of content on user client devices.

15. The system of claim 14, wherein the user responses comprise user interactions with the item of content on the user client devices.

16. The system of claim 11, wherein the model comprises a regression model.

17. The system of claim 11, wherein developing the new item of content comprises:
identifying a subset of the plurality of features comprising highest sensitivities.

18. The system of claim 11, wherein developing the new item of content comprises modifying an existing item of content.

19. The system of claim 11, further comprising:
presenting the new item of content on a plurality of user client devices;
determining the performance indicator for the new item of content; and
updating the model based on the performance indicator for the new item of content.

20. An article, comprising:
a non-transitory computer-readable medium having instructions stored thereon that, when executed by one or more computer processors, cause the computer processors to perform operations comprising:
providing a plurality of items of content, each item of content comprising at least one of an image, a video, a sound, and any combination thereof;
extracting a plurality of features from each item of content;
determining a performance indicator for each item of content, the performance indicator comprising an indication of user responses to presentations of the item of content;
developing a model to predict the performance indicator for each item of content based on the plurality of features;
based on the model, determining a sensitivity between the performance indicator and each feature; and
developing a new item of content based on the determined sensitivities.
